(19) United States
(12) Patent Application Publication
(10) Pub. No.: US 2004/0240830 A1
(43) Pub. Date: Dec. 2, 2004

(54) Closing mechanism for a mechanical optical fibre splice

(76) Inventors: Jan Watte, Grimbergen (BE); Kathleen Bellekens, Winksele-del (BE)

Correspondence Address: MYERS BIGEL SIBLEY & SAJOVEC, PO BOX 37428, RALEIGH, NC, 27627, US

(21) Appl. No.: 10/490,466

(22) PCT Filed: Sep. 11, 2002
(86) PCT No.: PCT/GB02/04161

(30) Foreign Application Priority Data
Oct. 4, 2001 (GB) 0123829.4

(51) Int. Cl. G02B 6/00

(52) U.S. Cl. 385/137; 385/99

(57) ABSTRACT

A device (1) for splicing optical fibres (20, 21) comprises a body (2), a first alignment element (3a) having at least one groove (6) for accommodating optical fibres, a second alignment element (3b) which can be brought towards the first alignment element (3a) to enclose optical fibres accommodated in the at least one groove (6), and a clamping element (11) for clamping the alignment elements together, The clamping element (11) is rotatable relative to the alignment elements (3a, 3b) from a first position in which the alignment elements are substantially loose to a second position in which the alignment elements are clamped together.

The present invention relates to a closing mechanism for a mechanical splice. More in particular, the present invention relates to a device for splicing optical fibres, the device comprising a body, a first alignment element having at least one groove for accommodating optical fibres, a second alignment element which can be brought towards the first alignment element to enclose optical fibres accommodated in the at least one groove, and a clamping element for clamping the alignment elements together. A device of this type is disclosed in U.S. Pat. No. 5,394,496.

Optical fibres can be interconnected or “spliced” in several ways. Fusion splicing involves heating the ends of the fibres to be spliced in order to produce a continuous transition. Mechanical splicing involves abutting the fibre ends in a suitable support or “splice”. As mechanical splicing does not require any heating, it is often preferred for splicing in the field. The mechanical splice device needs to be carefully designed to achieve a proper alignment of the fibre ends. Examples of such splice devices are disclosed U.S. Pat. No. 4,687,288 and U.S. Pat. No. 5,394,496. A special type of releasable mechanical fibre splice is a fibre optic connector. An example of such a connector is disclosed in U.S. Pat. No. 4,705,352.

The clamping element known from U.S. Pat. No. 5,394,496 has the disadvantage that it is difficult to loosen the clamping element as this requires the re-insertion of the (disposable) release wire. This re-insertion is all the more difficult as the grooves in which the wire ends are to rest move towards each other as the wire is removed. As a result, it is difficult or even impossible to rearrange the spliced fibres. This, in turn, makes this known arrangement unsuitable for use in a fibre optic connector.

It is an object of the present invention to overcome these and other disadvantages of the. Prior Art and to provide a device for splicing optical fibres which allows an easy release of the clamping element so as to free the alignment elements.

It is another object of the present invention to provide a device for splicing optical fibres which is simple and economical.

It is a further object of the present invention to provide a closing mechanism which is also suitable for fibre optic connectors.

Accordingly, the present invention provides a device as defined in the preamble which is characterised in that the clamping element is rotatable relative to the alignment elements from a first position in which the alignment elements are substantially loose to a second position in which the alignment elements are clamped together.

By providing a rotatable clamping element the rotation of which causes the clamping action it is easy to undo the clamping by reversing the rotation.

There is no need to provide a removable release wire or other removable release member. Instead, the rotatable clamping member preferably stays attached to the splicing device so as to be readily available.

In a preferred embodiment, the clamping element is provided with protrusions which fit, in the first and second position, in respective channels provided in the alignment elements or in the body. That is, the clamping element has an approximately circular cross-section from which at least one positioning member (protrusion) protrudes towards its interior and is, in the said positions, accommodated in a channel provided in the outer circumference of the alignment elements or of the body. The clamping element has a certain resilience which allows it to slightly bend outwards when rotated so that the protrusion(s) can leave the channel into which it is accommodated. Preferably, the clamping element is provided with two opposing protrusions.

When the two alignment elements are brought together any fibres accommodated in a groove are effectively clamped between the alignment elements the gap between the elements is reduced. However, too much pressure on the fibre(s) may cause damage and/or transmission losses. It is preferred, therefore, that at least one of the alignment elements is provided with a spacer member which abut the other alignment element when the alignment elements are brought together. This causes a small gap to remain thus preventing excessive pressure on the fibre.

In a preferred embodiment the at least one groove in the first alignment member is substantially V-shaped and the second alignment member has no groove. This results in the position of the fibre(s) in the groove(s) being defined by three contact points, thereby making a very precise alignment possible.

Although it would be possible for the clamping member to be rotatable over 360°, it is preferred that stop means are provided for stopping the clamping element relative to the alignment element after rotating over a certain angle, said angle preferably being approximately 90°. This prevents the clamping member being rotated beyond a certain desired position. Advantageously, the stop means comprise a stopping protrusion provided an at least one alignment element and a slot provided in the clamping element for accommodating the stopping protrusion.

The clamping element is preferably made of metal, for example sheet metal, although it could also be made of plastic or another suitable material.

The alignment elements may be separate parts which are accommodated in the body. In a preferred embodiment, however, the first alignment element or the second alignment element is integral with the body. This reduced the number of parts and facilitates the assembly of the device. In a preferred embodiment, the device further comprises keying elements in which the fibres may be fitted for defining their relative angular orientation.

The present invention further provides a kit-of-parts for forming an optical fibre splicing device as defined above.

The present invention will now further be explained with reference to exemplary embodiments illustrated in the accompanying drawings, in which:

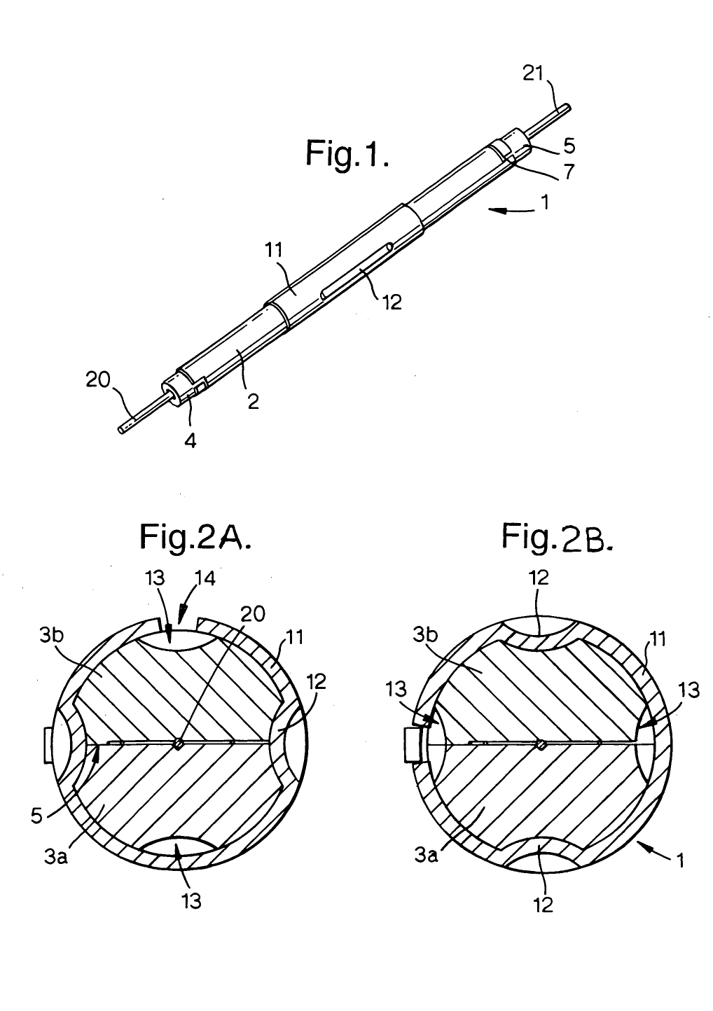

FIG. 1 schematically shows, in perspective, an optical fibre splice according to the present invention;

FIGS. 2A and 2B schematically show a cross-sectional view of the optical fibre splice of FIG. 1;

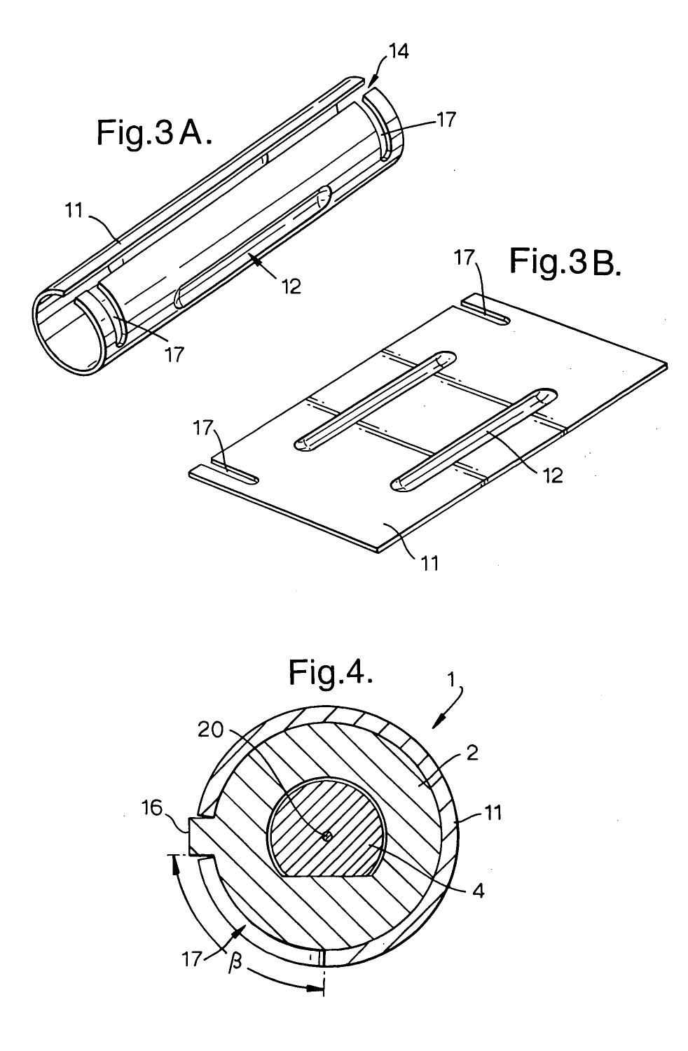

FIGS. 3A and 3B schematically show in perspective the rotatable clamping element of the optical fibre splice of FIG. 1; and

FIG. 4 schematically shows another cross-sectional view of the optical fibre splice of FIG. 1.

The mechanical splice 1 shown merely by way of non-limiting example in FIG. 1 comprises a body 2, an alignment member 3 (not shown in FIG. 1), keying elements 4, 5 and a clamping member 11. Optical fibres 20, 21 protrude from the keying elements 4, 5.

As will be explained later with reference to FIGS. 2A and 2B, the clamping member 11 is rotatable relative to the body 2 so as to close the alignment member and thereby align the ends of the optical fibres 20, 21.

As can be seen in FIG. 1, the keying elements 4, 5 are also rotatable relative to the body 2. Their rotation, which is limited by the lengths of respective slots 7 shown in FIG. 1, is independent of the rotation of the clamping member 1 and merely serves to attach the keying elements to the body.

As shown in FIG. 2A, which is a cross-sectional view through the splice of FIG. 1 at the deformations 12, the alignment member consists of a first alignment element 3a and a second alignment element 3b. These elements are enclosed by the clamping member 11. FIG. 2A shows the clamping member 11 in a first position, in which the alignment elements 3a, 3b are not clamped together and are therefore “loose” (that is, moveable relative to each other). FIG. 2B shows the clamping member 11 in a second position, in which the alignment elements are clamped together by the clamping member.

As shown in FIG. 2A, the clamping member 11 has two deformations 12 which extend inwards, that is, towards the alignment elements 3a, 3b. The deformations 12 rest in channels 13 provided in the alignment elements 3a, 3b. A gap 14 allows the clamping member 11 to bend open. When the clamping member 11 is turned, the protrusions 12 leave the channels 13 in which they were resting, thus bending the clamping member open until they reach the next set of channels 13.

In the second position shown in FIG. 2B the alignment elements 3a, 3b are clamped together. This causes the ends of fibres 20, 21 accommodated in the V-groove 6 to be precisely aligned. A spacer member 15 defines a minimum gap between the alignment elements. Although the clamping member 11 could, in principle, be rotated over 360°, a preferred embodiment is provided with stop means for limiting the rotation to 90°. This prevents the clamping member being accidentally turned past the desired position.

The stop means are shown more clearly in FIGS. 3A, 3B and 4. FIG. 3A shows the clamping member 11 which is preferably made of metal. If the clamping member is made of sheet metal it may be initially be produced flat, as shown in FIG. 3B, and be made to curve in a further production step.

As shown in FIG. 3A, the preferred clamping member is provided with two slots 17 which extend over approximately 90° of the circumference of the clamping member. A stop 16 protruding from the body 2, shown in FIG. 4, is accommodated in a slot 17 and thereby defines the angle (β) over which the clamping member can be rotated relative to the body.

It should be noted that one of the alignment elements may be integral with the body 2, and that the alignment elements may connected by a so-called “living hinge”, thereby effectively also being integral.

It will therefore be understood by those skilled in the art that the present invention is not limited to the embodiments shown and that many additions and modifications are possible without departing from the scope of the present invention as defined in the appending claims.

1. A device for splicing optical fibres, the device comprising:
a body,
a first alignment element having at least one groove configured to accommodate optical fibres,
a second alignment element, which can be brought towards the first alignment element to enclose optical fibres accommodated in the at least one groove, and
a clamping element configured to clamp the alignment elements together, wherein the clamping element is rotatable relative to the alignment elements from a first position in which the alignment elements are substantially loose to a second position in which the alignment elements are clamped together.

2. A device according to claim 1, wherein the clamping element is provided with protrusions which fit, in the first and second position, in respective channels provided in the alignment elements or in the body.

3. A device according to claim 2, wherein the clamping element is provided with two opposing protrusions.

4. A device according to claim 1, wherein at least one of the alignment elements is provided with a spacer member which abuts the other alignment element when the alignment elements are brought together.

5. A device according to claim 1, wherein the at least one groove in the first alignment member is substantially V-shaped and wherein the second alignment member has no groove.

6. A device according to claim 1, wherein stop means are provided for stopping the clamping element relative to the alignment element after rotating over a certain angle (β).

7. A device according to claim 6, wherein the stop means includes a stopping protrusion provided on at least one alignment element and a slot provided in the clamping element that accommodates the stopping protrusion.

8. A device according to claim 1, wherein the clamping element is made of metal.

9. A device according to claim 1, wherein either the first alignment element or the second alignment element is integral with the body.

10. A device according to claim 1, wherein the body is plastic.

11. A device according to claim 1, further comprising keying elements in which the fibres may be fitted to define their relative angular orientation.

12. A kit-of-parts for forming the device of claim 1.

13. The device of claim 6, wherein the certain angle (β) is approximately 90°.

14. The device of claim 8, wherein the clamping element comprises sheet metal.
